(19) United States
(12) Patent Application Publication
(10) Pub. No.: US 2008/0281793 A1
(43) Pub. Date: Nov. 13, 2008

(54) Method and System of Information Engine with Make-Share-Search of consumer and professional Information and Content for Multi-media and Mobile Global Internet

(76) Inventor: Anup Kumar Mathur, Sunnyvale, CA (US)

Correspondence Address: Anup Mathur, 1731 Chitamook Ct., Sunnyvale, CA, 94087, US

(21) Appl. No.: 12/013,411

(22) Filed: Jan. 11, 2008

Related U.S. Application Data
(60) Provisional application No. 60/884,607, filed on Jan. 11, 2007.
(60) Provisional application No. 60/893,223, filed on Mar. 6, 2007.

(51) Int. Cl. G06F 17/30; G06Q 30/00

(52) U.S. Cl. 707/3; 705/14; 707/E17.001

(57) ABSTRACT

The method of Make, Share and Search Integrated System, improves the user experience of creation and consumption of information content, with instant access to newly created and dynamic information. The new system also reduces or eliminates the need for web crawlers, by capturing search parameters at the time of creation itself, and improves the same whenever any user utilizes the same, to enable instant access to new information. In the next generation of web, content creation by consumers is going to far exceed any professional content, and new Make, Share and Search Integrated System enables this in a superior manner than any of present day technologies do. Further the system is designed for multi-media and mobile environment with global reach, and provides users with creation, sharing, prioritization, search, utilization and consumption in a single integrated technology, replacing the present day “Search engine” paradigm by a new paradigm called “Information Engine”.

### PRIORITY CLAIM

This application is related to and claims priority under 35 U.S.C. §119(e) to a commonly assigned provisional patent application entitled “Method of Information Engine with Make-Share-Search for Multi-media and Mobile Global Internet” by Anup K. Mathur, Application Ser. No. 60/884,607 filed on Jan. 11, 2007 as well as commonly assigned provisional patent application entitled “Web 2.0 information search and presentation” with “Consumer=Author” and “Dynamic Information Relevance” models delivered to “Mobile and Web Consumers” through “Sponsored Web” and “Global Keywords” business methods” by Anup K. Mathur, Application Ser. No. #60/893,223 filed on Mar. 6, 2007.

### KEYWORDS

Web Search, Search Engine, Web Server, Web Crawlers, Context Search, Content Popularity, Web Page Ranking, Search Session, Information Sharing, Information Creation, Information Search, and Information Engine.

### BACKGROUND OF INVENTION

Search technology as per state of the art today, relies upon web capture software (Web Crawler Model) assembling a database view of the web as it evolves and in the process creating a lookup system based on words and corresponding web pages which contain such words (also known as Inverted Index Table Model). The inverted index table is constantly updated as new web pages or new versions of existing web pages are gathered by Web Crawlers running 24×7 across the global Internet.

Given a search word by consumer, the system looks up the inverted index table for corresponding web pages and presents these in a specific order. In case of a market leading offering, such an order is pre-decided statically, using the number of important web pages that link to the target web page, giving assessment of global static rank of the web page and hence consider it more relevant (also known as Relevance Model).

Today's web has already reached more than 3 Billion web pages, and around 10 Million words, where search engines service millions of customers at the same time, by achieving parallelism of search across users through load balanced arrays of servers (Parallelization Model), computing this lookup and returning the most relevant results.

To create revenue, the keywords are used for looking up a corresponding banner advertisements or sponsored links (Advertising and Sponsorship Model), and these are presented to user along side main search results; and hence for every click through of a sponsored link by user, the search engine gets paid a small amount of money. Sponsors bid for individual keywords for each click-through of end user of their links, and these are presented separately, usually in right column to end users. Current rates of click-throughs are around 10% for sponsored results with some risk of fake click-throughs.

With free search offerings on the Internet, millions and millions of queries are posed every day, by consumers; making advertising or sponsored link the main source of revenue and through this model leads to large revenues reaching billions over a financial year (Revenue Model). The market size is governed by share of Internet advertising which has already reached around $12B in 2006 and is increasing globally in percentage share of overall advertising and marketing budgets of enterprises, which is around $1T globally.

Additionally, search is also responsible for a large percentage of Internet shopping and hence combination solutions of shopping and search command an even bigger market (Internet Shopping Model). This model has the potential to extend itself to Mobile based comparative shopping, a new and promising field (Mobile Search and Shopping Model).

Somewhat unrelated solutions present today are based on users creating their profiles and sharing these with global audience for social purposes (this is called Social Networking); popular sites of this model are MySpace and FaceBook, which have attracted young people to publish their profiles, with photos and videos and hence have become popular. These models involve creation of a social profile by consumers using friendly tools, and in some cases also allowing them to upload HTML and similar scripts directly.

Another aspect of new trends in the web include uploading and sharing of videos and photos (Upload and Share Videos and Photos model) to sites such as YouTube and Flickr, where users can upload their videos or photos etc. and share with the rest of the world. These sites are server based storage spaces and with some built in search capabilities using text based captions and they also track popularity of content based on how many users have viewed the content; and present most popular videos first. The problem is lack of maturity of the solution which leads to no control of who sees what content, and hence does not service most consumer needs properly. The systems also require users to upload their content, which again is less convenient and laborious, and users would rather see a friendlier solution to this problem.

Other directions in search include location based searches such as presented by Google Earth and MapQuest towards map oriented search. Shops sponsoring these location based results can post their location, as well as coupons to the site for consumers to take advantage of when they search a location (Location Based Search).

Supplementary solutions in search are desktop search, where solutions exist from Google and Microsoft; which allow searching across a desktop PC, and indexing the e-mails, documents and web pages to present as needed by the end user. This method has not really become popularity due to speed being slow as well as users being sensitive to installing external software that takes significant compute power on their PCs (Desktop Search).

On the creation side, present day search engines have been designed to work with web pages that are created by authors using offline web page creation tools, including web page authoring tools. Such web pages are hosted on websites and crawled by search engineers to identify and build search indexes.

New development in creation include enhancements of office applications such as Microsoft office that now allow users to save their documents, such as Word documents, Powerpoint documents and Excel spreadsheets as web pages. These web pages are then uploaded by users or user representatives into web sites which a search engine crawls to discover them and thus go about indexing the same for future search. This creates a disjoint experience for users, since act of creation is different from act of access over web which is different from act of search on the web, which can therefore lead to miscommunication or inadequate access to information.

Newer development in this direction include Google Apps, which allow users to create online documents where documents are created using web browsers, and stored on servers somewhere on the Internet. This model allows sharing and access of documents between users and eliminates multiple instances of documents that are often sent over emails. At the same time, if a user does not have access to the Internet, the documents can not be easily accessed, leading to lack of information access. Further, search engines are not integrated yet with these systems, making it difficult for users to create information for the public web which can be searched by every one.

Therefore, both solution approaches i.e. like Microsoft Office as well as like Google Apps have potential drawbacks from end user view points, even as these service quite a few requirements and hence have gained popularity.

Further, such systems are primarily designed for PC and/or web based access, and only limited mobile functionality has been created, which provide access to emails, and web pages. Such mobile offerings have been made by Yahoo, Google and Microsoft and others, but are very limited in functionality with unpredictable connectivity, quality of presentation and response times. Given that mobile phones have far more reach in the world today than the PC based Internet, mobile Internet has the potential to bring each and every human online, provided new solutions can be designed that meet this requirement from ground up.

### BRIEF SUMMARY OF INVENTION

A new method and system called Information Engine is presented, with Make, Search and Share Integrated User Applications with a Three level Multi-media web model for the Internet and Mobile Web, which deviates from established paradigm of web search engines (which only search), or Document Creation applications (which only create documents or web pages). The new system through its various methods improves on the user experience of information creation, communication and consumption by other users of the Internet worldwide in a timely and relevant manner through web and mobile access models.

Additionally, the new method of Information Engine, with its Make, Share and Search integrated models enables capture of search parameters at the time of creation, as well as each time any user utilizes or views a creation, of any other user, to result in a dynamic and vibrant search model that makes new information available to global users instantly, while eliminating the need for existing web crawler technology used by present day search engines.

The following describes various features and embodiments of the invention without limiting the scope and applicability of the invention as captured in claims herein.

### BRIEF DESCRIPTION OF SEVERAL VIEWS OF DRAWINGS

FIG. 1: Information Engine Model 1 for Low Capability Consumer Devices and Information System with direct interoperability With Central or Global Information Engine Server over Wireless, Mobile and Broadband Internet.

FIG. 2: Information Engine Model 2, with Additional Feature of Information Engine Device Instance, providing universal access for Device based information from any other device via Information Engine Server Instance.

FIG. 3: Information Engine Model 3, with Home Server Instance of Information Engine for Home internal information services and within Home Network for residences, residential complexes, hotels, small businesses etc.

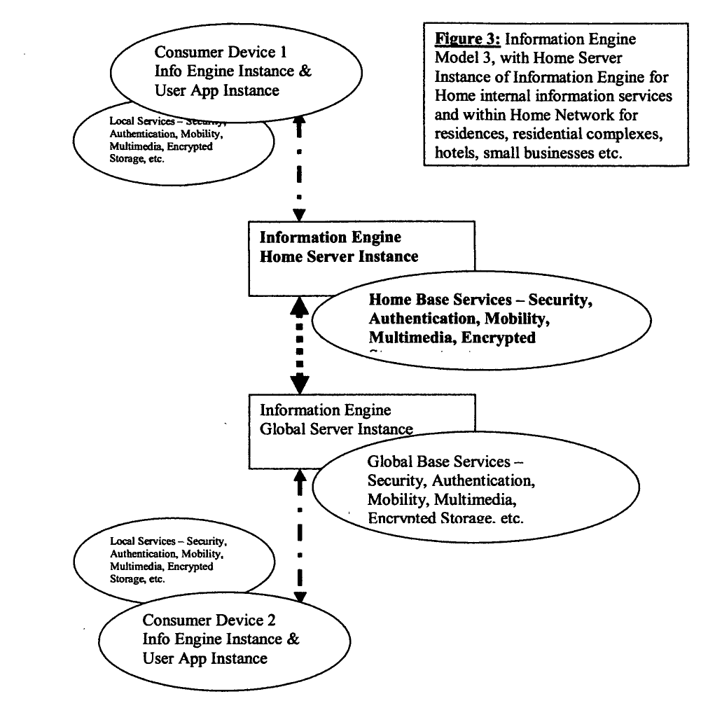

FIG. 4: Information Engine Model 4, with Web 2.0 Search unified with Information Engine to create Global Information Engine for Search and Information System in one.

FIG. 5: Information Engine Model 5, with Make, Share, Search, Communicate and Collaborate Services defined as Make and Share business method. Sharing based on private or public model only; where public sharing will automatically make the content created available through web 2.0 search engine to global Internet.

FIG. 6: Information Engine Model 6 with Make and Share and Web 2.0, in combination With Method of Information Space; which determines for each information or content, what gets shared with who, from personal, to friends to public.

FIG. 7: Information Engine Model 7, using Home Based Information Engine Server Instance Interoperating with In-Home and Outside-Home Consumer Devices over Wireless, Mobile and Broadband Networks defined as Home Information Network (HIN), with potential embodiments for Consumer Residences, Residential Complexes, Small Businesses etc.

FIG. 8: Information Engine Model 8, with Service Creation and Consumption by Consumers, using service descriptor for defining, consuming and user interface; with underlying make-search-share-consume model.

FIG. 9: Information Engine Model 9, with Make & Share, Web 2.0 Search with Web Services search and consumption system Architecture; Direct Interoperability Through The Global and Geo-Distributed Network of Information Engine Servers, with Information & Application Redundancy, Rapid Switchover and Emergency Recovery Systems.

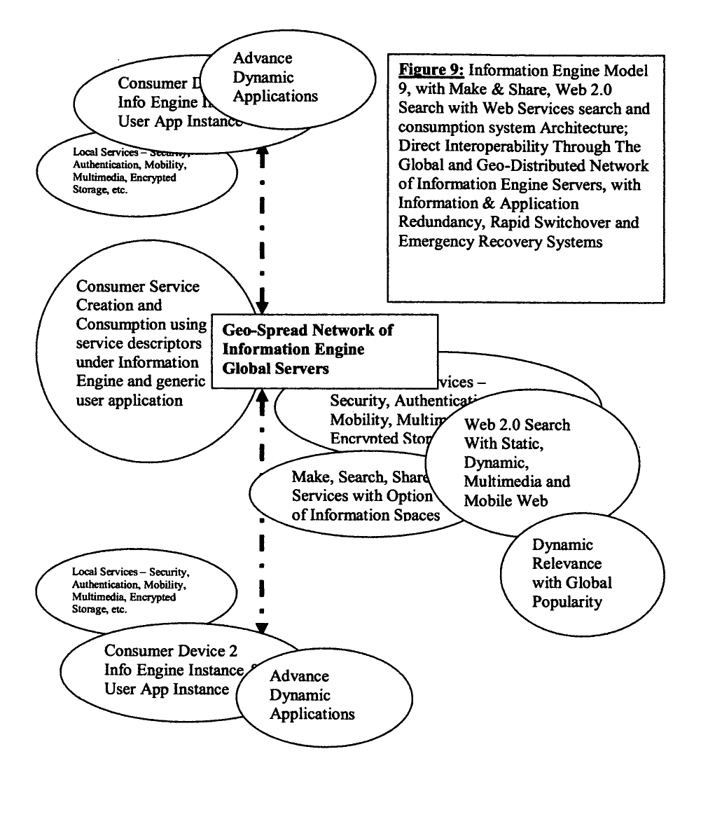

FIG. 10: Information Engine Model 10, with Multi-media content model consisting of element, page and document, where an element can be referenced by one or more pages, a page can be referenced by one or more documents, and each such element, page or document is globally uniquely addressable and hence can form result of a search or can be output of make operation or can be shared using information space.

FIG. 11: User Interface Prototype of Make, Share, Search User Agent software replacing or enhancing web browsers, and showing Automatic Advertising in this specific embodiment. A similar embodiment can be created for a mobile device such as a smart mobile phone where the user interface is proportionately adjusted and/or made scrollable or paginated to meet the display surface requirements of the mobile device. Another embodiment the mobile user interface may be voice command based, or may be embedded into the mobile device itself such as the Windows Mobile, iPhone or Google Phone OS to create a more friendly user interface for the end users.

### DESCRIPTION OF INVENTION

As more and more consumers wish to create content which becomes searchable on the web, a new method and system is specified which brings together make, search and share solutions into a single unified “Information Engine”, as follows.

A new system called Information Engine, with Make, Share, Search integrated model is presented which treats creation, viewing, access, prioritization, search, utilization and consumption of information, static or dynamic, consumer created or professionals created or even applications or service created, in a single uniform global solution, which is universally available on the web, on mobile phones and other form factor consumer computing devices.

“Web Search”, “Multimedia Document Search” and “Mobile Search” is unified with “Consumer=Author” model through integrated “Make, Share and Search” method addressing “Consumer and Professional Content”, “Visible and Invisible web” as well as “Web 2.0” and “Web Services” based information, combined with “Information Direct” model to result in new “Information Engine” supported by “Sponsored Consumer Content”, “Sponsored Professional Content” as well as enhanced models for “Keywords based Sponsor Links”, in addition to and not limited to “Software As A Service” business models, and providing access from “current and new form factor consumer computing and communication devices” over “wired, wireless and mobile Internet” using web browser, integrated “make-n-search” or “make-n-share” or “search-n-share” devices, user agents, or applications.

Web search model is enhanced with Make model to create a unified “Make-n-Search Engine” with “Consumer=Author” model where information creation and search are both unified by the new engine.

Make-n-Search Engine with “Consumer=Author”: Allows any consumer to create and author information rich multi-media content, and make it available to the global Internet through the Make-n-Search Information Engine, breaking the current separation between content creation and content search; thus this new system makes the playing field level between consumers and professionals for web content creation and consumption. The system over time also reduces the need for web crawling as Make-n-Search “Information Engine” gathers momentum and allows more and more content to be created and searched smartly within the geographically spread and yet interoperable global Information Engines.

The new information engine enables user software, user applications and user devices to directly capture search parameters of any information, content or web page a user views, uses, creates or accesses using such a user agent. These search parameters are automatically captured at will by user agents and communicated with user designated Information Engine(s) which utilize these content or web page specific search parameters to dynamically update searchable index of information. This model enables instant updates of search indexes of Information engine, the moment a user creates a content, or another user views or consumes new content.

Search parameters automatically captured may include words, phrases, web URLs, context, topic, themes, ideas and other key parameters required for delivery next generation of search via the Information Engine. Further, such capture is done with user willing participation, and user designation of specific Information Engine. This model further enables stripping out of any confidential information such as bank account details or personally identifiable information, which the user may not wish to disclose to public at large.

Integration of Make-n-Search allows new information to be gathered from authors, such as <info> or <mobile> tags, which are defined by this method, to capture abstract of a web page under <info> tag and mobile content equivalent for the web page under <mobile> tag, within the same page, allowing to service “mobile search” and “Information Direct” features, more smartly than search only engines can do.

An extended method of the Make model leads to every web page or information container becoming more intelligent and informing the Information Engine of changes registered by the user, reducing further mediation by web site administrators and wastage of Internet bandwidth by web crawlers; while improving information availability.

Mobile Link—Creation of mobile page content and/or link in main web page for every new web page created by an author. When requested from a mobile device, the system fetches the mobile page equivalent, which is written by author or if not available, automatically reduces from main page by the use of reduction and pagination method. Mobile search results and corresponding content may optionally be made available via mobile friendly text messaging and interactive voice response systems, provided author enables such an access to his or her content.

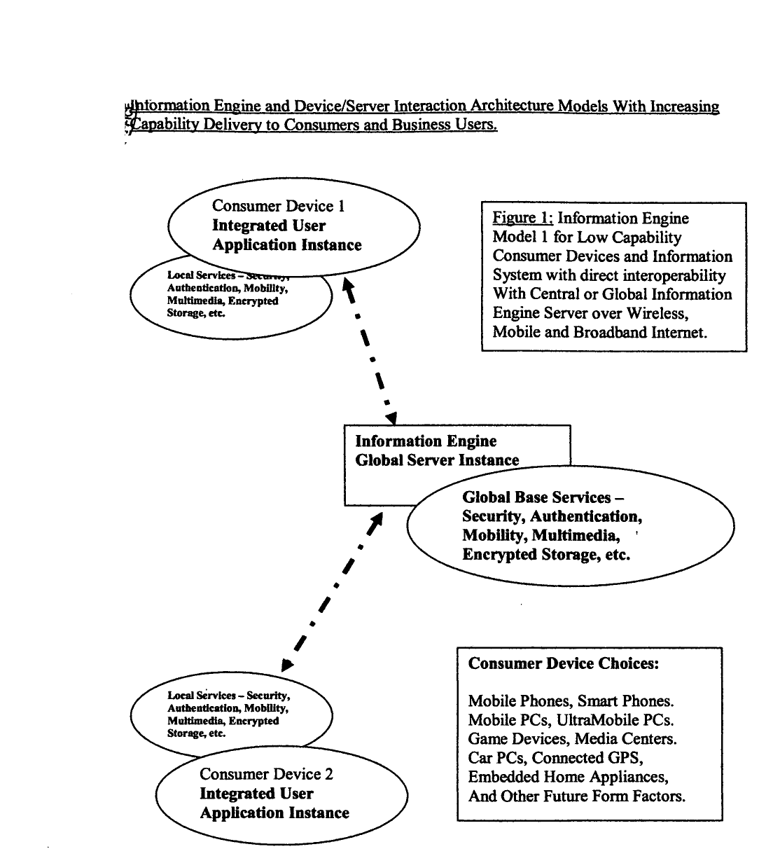

In a basic system, Make-n-Search Information Engine can be constituted as global software service, hosted web site, or system of geo-spread web services, accessed globally over the Internet, using a web browser based user interface, or through a more attractive make-n-search integrated user application model that replaces the web browser, on every consumer device whether it is a PC or a mobile phone. Such a model has the advantage of being accessible by global consumer base quickly and without having to install software locally on their systems. [See FIG. 1]

In an alternate method, Information Engine Agents may be allowed to be downloaded and hosted by existing or legacy web sites or web site providers where such engines can cooperatively work across the web to create hundreds of information engines in a grid fashion with common relevance model, eliminating or reducing the need for periodic crawls, and improving the overall consumer satisfaction without having to increase the infrastructure needs.

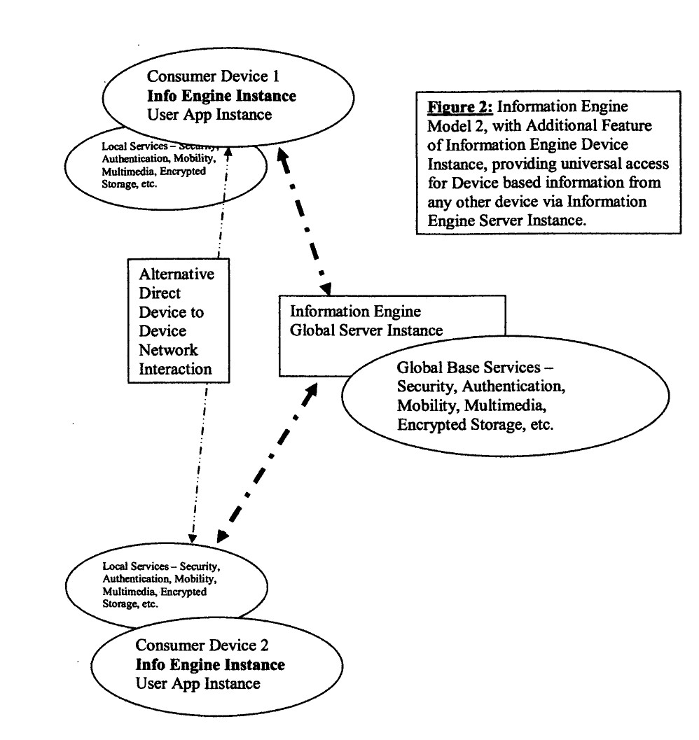

In an advance system, a variant of “Information Engine” runs on every user device, with feature flexibility as may be appropriate based on computing and communication capabilities of the said device as well as the intended role of the device with respect to a consumer or business application. The “device Information Engine” cooperatively interoperates with a “home Information Engine” or with a “global Information Engine” or combinations of “home and global Information Engines”, to enable every device accessible and searchable for every consumer content, globally, in real time, while providing secure sharing models, i.e. private, home, family and friends or group, professional and public, or as may be selected by creating consumer. [See FIGS. 2,3]

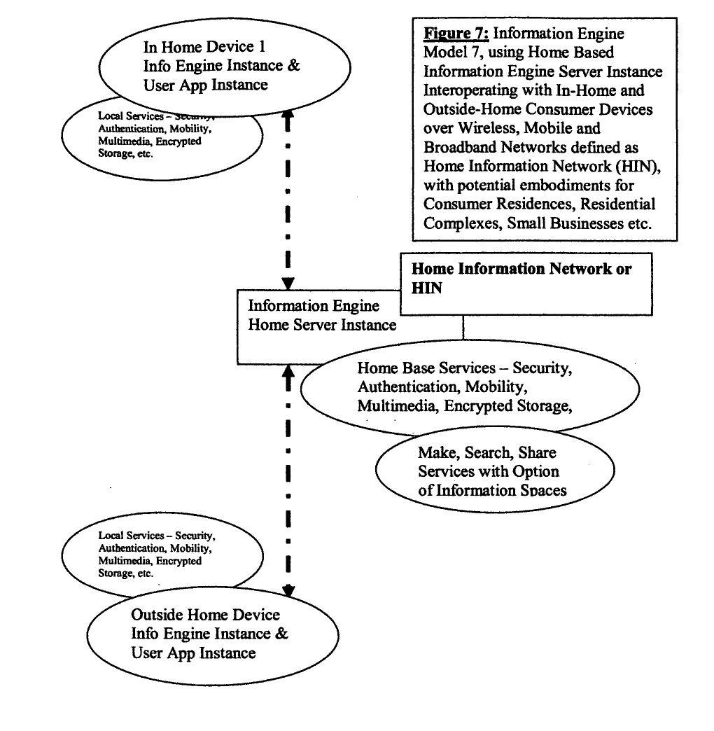

Information Engine for home may be a local home server or be serviced by a central Information Engine such as for residential complexes, small businesses, hotels, resorts, business parks and multi-storied buildings. Further, each home can host its own Information Engine server, as well as have device specific Information Engines running on every device, from PCs to mobile phones. Home based Information Engine server shall interoperate through firewalls in a secure manner, as per user preference to provide access to home information to user while away from home, or to friends and family as per user wishes, or to public as per user wishes. In case of public sharing by user, such specific content or information provided by user, becomes searchable and usable by the consumers globally, through the Information Engine, at par with any web page on the Internet. [See FIG. 7]

Information Engine thus creates a uniquely identifiable “presence” of “every home, every device and every user” on the global Internet, and makes the corresponding information available through Information Engine search models, while ensuring that only that part of information is exposed as may be allowed by information owner user for a specific audience.

Uniquely identifiable Information Engines of various forms securely interoperate with each other through encrypted and authenticated communication methods as per the authorization models specified by end users or by the global Information Engine, as per desires of its users.

A unified user method to create, share, search and consume multi-media consumer information, including text, documents, spreadsheets, presentations, photos, videos, audio, music, drawings, web pages, blogs, wikis, and other emerging media; and automatic storage of such multi-media information on user designated device locally, on home server or centrally or any combination thereof, to allow for global access by consumer through the Information Engine and presented via a web interface, an application agent or Make-Share-Search Integrated Application, for their various applications and endeavors including but not limited to personal, social, professional and public applications.

A unified method for mobile digital devices consisting of create, share, search and consume operations of multi-media consumer information and content, including text, documents, spreadsheets, presentations, photos, videos, audio, music, drawings, blogs, wikis, and other emerging media, including automatic storage of such multi-media information on user designated device locally, on home server or centrally or any combination thereof, through the Information Engine for use across their various endeavors including but not limited to their personal, social, professional and public endeavors, using any mobile web, computing, communication or entertainment device.

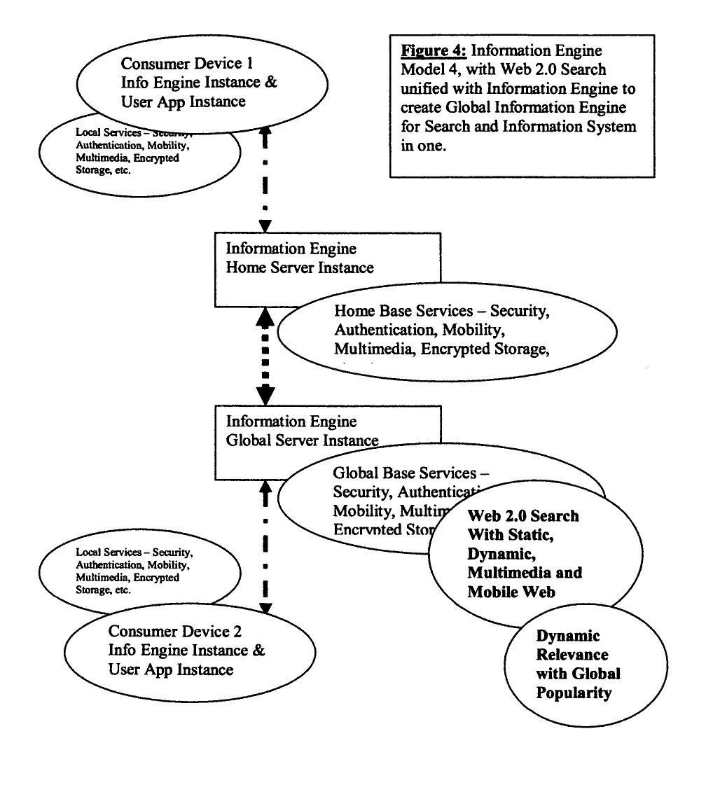

“Make-n-Search”: Integrated search and make user software to create a new model of user interaction for web and mobile web. As an additional model to web based make, share and search user interface presented through web browsers, the optional Make-n-Search Integrated software enhances the present day web browsers and creates a replacement for improving consumer experience. The integrated user software or agent operates in user device environment and thus presents user interface models that are appropriate and leverage local computing, communication, interaction and display capabilities of the specific user device. This method extends itself to mobile phones, smart phones, media centers, smart TVs, mobile PCs, tablet PCs, game consoles, and personal media devices, wireless automotive PCs, and any other new form factor that is capable of supporting part or all of Information Engine user functionality. The software functionality trims or extends based on device capabilities, while producing same format output both ways i.e. in Make mode and in Search Mode. Thus items created using a mobile phone can be stored on Information Engine and searched using a smart TV, in a single unified system. [See FIG. 4]

“Make-n-Share”: A unified user method to create, share, and consume multi-media consumer information, including text, documents, spreadsheets, presentations, photos, videos, audio, music, drawings, web pages, blogs, wikis, search results, and other emerging media; and sharing of such multi-media information for their various application areas. Make-n-Share method permits creation of text note for example and instant sharing of such a note with another consumer or user without having to follow current state of the art in which such a note is attached to an e-mail or instant message and sent to another user. Sharing is instantly achieved through the global Information Engine or interoperating network of Information Engines, between the creator of note and receiver of such a note, without users having to explicitly do so. Further, such a sharing is qualified in terms of view only, view and edit, view/edit and collaborate within specified group, or view/edit/collaborate with public at large or any combination that users may desire. The method of Make-n-Share reduces user tasks required for such a sharing.

“Search-n-Share”: Multi-media information including search results can be shared with friends defined in Search, Make and Share model either directly by clicking on share button or equivalent, and selecting friends or family group to share with; system can be applied to web browser, dedicated user application or for mobile search environment. In case of mobile search, sharing will result in all friends receiving the shared result notification on their mobiles in real time.

“Mobile Make-Share-Search”: A unified method consisting of use of mobile digital devices, over public or private wireless networks and the wireless Internet, to create, share, search and consume multi-media consumer information including text, documents, spreadsheets, photos, videos, audio, music, drawings, web pages, blogs, wikis' and other media, and storage and access to enable the same across their various endeavors including personal, social, professional and public, using any networked device with web access including mobile digital devices.

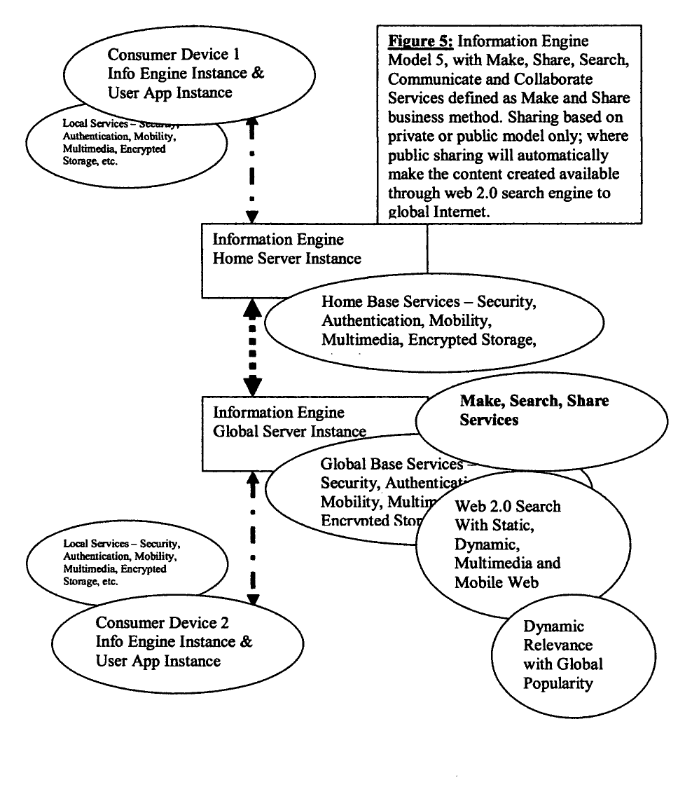

“Multi-media Make-Share-Search”: Multi-media information including search results can be shared with friends defined in Search, Make and Share model either directly by clicking on share button or equivalent, and selecting friends, family, group or public to share with; system can be applied to web browser, dedicated user application or for mobile search environment. In case of mobile search, sharing will result in all friends receiving the shared result notification on their mobiles in real time. [See FIG. 5]

Multi-Media Make-Share-Search: A new web model is defined in three levels as a Multi-media container document (MMDoc), Multi-media container page (MMPage) and a Multi-media element (MMElement); to represent rich text, photos, video clips, video streams, Paintings, Games, Animated Clips, Documents such as presentation files, photo albums, and e-books, 2D and 3D drawings, for new emerging complex multi-media content rich applications.

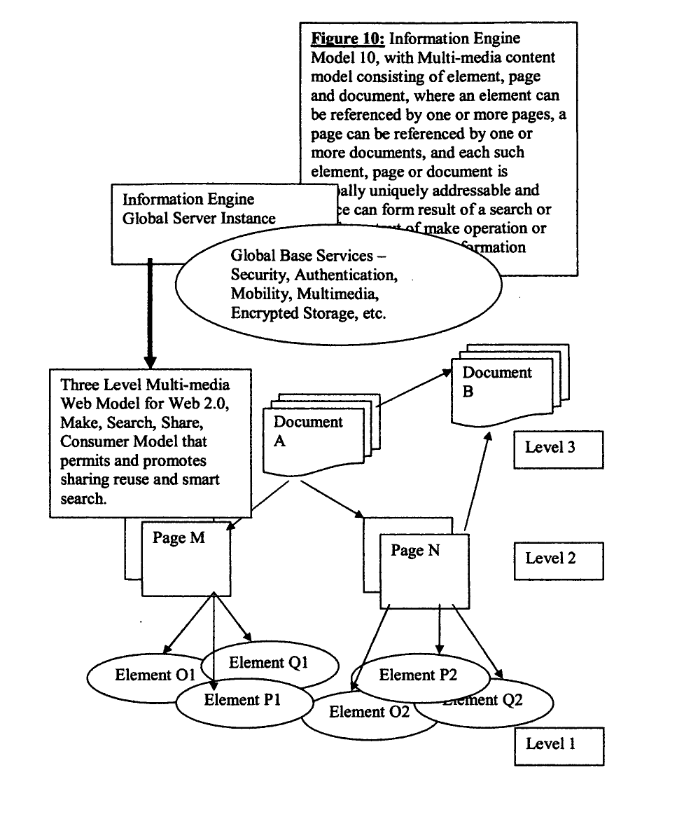

Multi-media Make-Share-Search—The new method of Make, Share and Search, allows direct creation of multi-media content with three level Multi-media model, and allows make-search-share-consume operations at either of the three levels. One or more MMElements constitute a MMPage; and several MMPages can constitute a MMDoc. This method models constitution of complex documents from a variety of media elements, with reuse of MMElements across several MMPages and reuse of MMPages across several MMDocs. This method allows search relevance to be defined not only for a web page as it is done in present day state of the art in search engines, but also for elements at any of the three levels i.e. MMElement, MMPage and MMDoc, where MMPage is similar or equivalent to a present day web page or a power-point slide, while MMDoc is equivalent to an entire e-book or an entire presentation, and MMElement is equivalent of a individual photo, image or rich text contained within a slide or web page. For example, a presentation consists of a deck of several slides, where each slide may refer to or contain one or more drawings, pictures, charts with complementary text. Likewise a MySpace like social network page may consist of several pictures and text by author, and some other notes or pictures by their friends, making the web page complex, as well as dynamic i.e. changing very frequently and requiring different relevance rating for each of the content items within the page. This new multi-media search system models this dynamic and multi-media nature of the information to create an improved representation, and hence improves on creation and access of such information. This brings forward a new generation of search and information applications which can take advantage of the emerging nature of consumer created multi-media web, moving forward from earlier text only representations of the web, mostly created by professionals. [See FIG. 10]

A new three level multi-media web model for Make, Share and Search, allows an element to be referenced or contained by several pages and a page to be referenced or contained by several different documents, where such an element, page or document is globally and uniquely addressable and conforms to the sharing model specified by its creator user, through the Information Engine or Network of Information Engines. Thus creating potential of sharing and reuse amongst users across the Internet and hence creating a new paradigm which goes beyond present day video upload and share models. Additional parameters are captured at the Make time for each level, which facilitate targeted search for consumers through the Make-n-Search engine for the public Internet, and thus creating opportunities for better and improved search results than are presently possible.

A new three level multi-media web model is also extended to the mobile web, where photos or videos can be taken from Camera phones, with the Make model applied to the three level multi-media web model, is used freely to create new and higher level shared e-albums and e-invitations and like; as well as combined with “Share model”, it also further creates opportunities for selective sharing through the Information Engine. Contrasting this with present day models, where creating software is different from the searching software which is different from the upload, search and playback systems, and hence the only way one can share videos or photos currently is to upload to the sites like YouTube as a single level object. Such an upload makes videos available, but not in a search friendly manner, and further due to single level model, it also does not permit reuse.

Multi-media search, with corresponding relevance for a new three level Multi-media web model with document, page and element, (with page representing a web page or presentation slide or video segment in a show; element representing a photo or image in that web page or presentation slide or a song video in a movie or show and a document representing an e-book or e-site containing the web page, or an entire presentation containing the slide or an entire movie or show containing the video segment), where paths leading to each level of multi-media model are used for relevance probability computation in form of a “Global priority index”, or (GPI). GPI is computed for each of the elements, pages and documents, where an element may be referenced by one or more pages, and a page may be referenced by one or more documents. GPI of a multi-level item in the Multi-media model is influenced by its container and contained references, and thus creating a much more consumer friendly relevance model in the new multi-media web environment, compared to traditional models of relevance computing for a web page created in text primary web environments, being used by present day search engines.

Multi-media directed search—if an element is uncovered through multi-media search, user can be shown choice of pages and documents that contain or refer to this element, to allow user to view or retrieve these. In one embodiment, user may be viewing a selection of music videos, on a media center PC or on a mobile TV capable phone or on a smart TV, and upon liking a selected music video, user shall be able to automatically search and view corresponding movie or show that has referenced or originated or contained this specific music video; and start playback of one such container movie selection without having to explicitly search for such a movie.

Multimedia annotations based search—an annotation layer for every multi-media element is created by user or by device, and used for searching. Such an annotation layer becomes part of the multi-media element, and hence is available even if such an element is moved, copied or its anchor text changed, ensuring that original or authored annotations are maintained through the lifecycle of the element. Further, user interface software for content creation may allow users to add an additional graphics layer on top of media content, which annotates the underlying content in a user friendly fashion. This annotation is used for searching, against context sensitive multi-media queries. Advantage of this approach is that annotations stay with the image or video, even as the referencing text page may change or anchor words may be lost or missing, resulting in a more surer search result.

Multimedia content comparator based search—based on media specific algorithms, such as comparison of photos by recognizing pixel groups and finding similarities by ratio of pixel groups being common between photos or video frames; or in case of streaming music or video similar methods that are media specific are deployed. This contrasts to any text based methods that use captions, annotation layer or similar models. User inputs for such method may be received by a digital camera, or by pointing to a photo or by specified areas on a photo or similar equivalents of a video. This is deployed selectively where such an algorithm is reliable and user can provide the corresponding inputs. Further, the system provides a plug-in comparator model where newer or third party comparator algorithms can be deployed in conjunction with search methods to identify the best match.

“Global and Dynamic Relevance based Search”: Global relevance of a web page reflects the overall global popularity of the web page; where as the Dynamic relevance reflects popularity of the web page in a specific context, time, location, appropriateness, or other dynamic parameters for a specific user and user information query. The global relevance is computed for a web page by identifying all the paths that pass through a web page and distributing probabilities in a successive fashion along these paths, with law of diminishing returns. The method can distribute probability in a uniform manner or non-uniform manner influenced by context similarity, or time similarity, or appropriateness similarity or location similarity or other parameters, of interest to consumers, or a combination thereof. Further, such relevance is computed for each of multi-media element, page and document, in the new multi-media web model, where each element influences its container level in computing relevance. Further, relevance can also be computed for each of the other elements including traditional web pages, mobile web and dynamic or invisible web, excluding dark web i.e. web pages with very few or no paths passing through them. This dynamic relevance may be computed for each of the information sources and/or search scopes separately or jointly and be presented separately or jointly in the user interface.

A simpler form of dynamic information relevance may be computed using a model called Collective Wisdom. In collective wisdom, web search parameter gathered by Make-Share-Search Integrated user software, replacing web browsers, are communicated with user will to designated Information Engine server or servers. Since these parameters are captured for the same content by all such users who create, modify, view or utilize this content, multiple versions of such search parameters for the same content arrive at different times at the Information Engine system. The Information Engine server receiving each such dispatch, processes it, and then combines that with other such dispatches to compute search indexes, along with frequency of usage by users of each such content. Search relevance is then defined as the frequency of usage in the relationship to the search query and search scope as identified automatically or explicitly specified by the user through query and/or context or combination inputs, via any of the Information Engine access models, from web to mobile devices. Collective Wisdom captures the collective usage statistics which is time variant and content variant, and thus enables highlighting of relevant information that is collective of interest to users. This eliminates large parts of obsolete or not-so useful web content that exists but users are no longer interested in the subject or specific content.

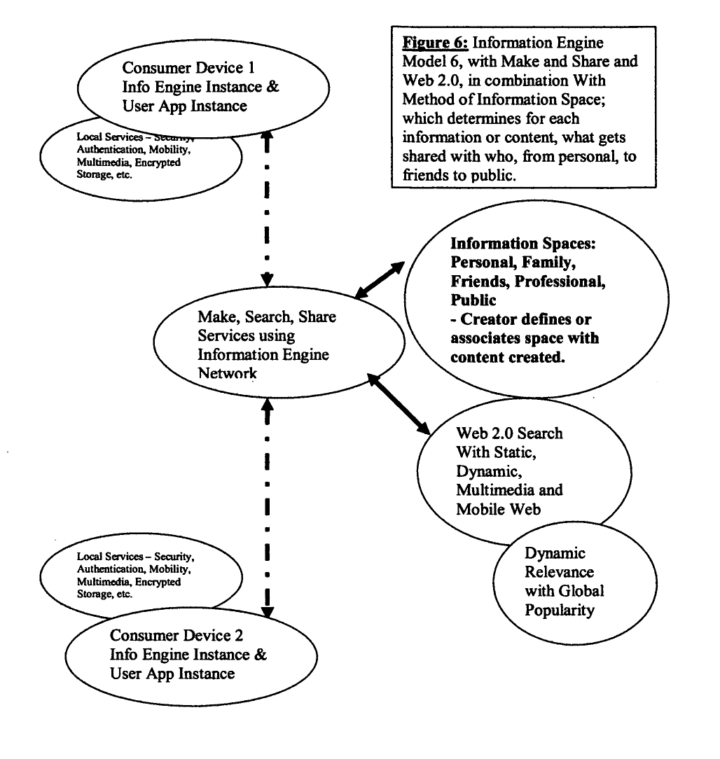

Information Spaces—In this enhancement of Information Engine, every document, page or element, created by or enhanced by the Make-Share-Search Integrated software gets associated with an “Information Space” which the author or creator decides and based on that such a document gets shared with a selected group of people, or publicly made available, or not shared at all i.e. kept private and secure, through the Information Engine. Under the method of Information Spaces, if a specific consumer carries out search, the set of web pages searched is determined by the search scope which is dynamically determined by either a selection by user of Information Space in which to search, or by intelligently searching for all documents, that qualify for the specific user i.e. by looking at every document, page and element, seeing its Information Space and identifying if the consumer has rights to view the document, and thus determine whether to include in the search scope or exclude the same. Further, results so identified may be presented in a single list or may be separated into different lists and identified with the source of information along with its corresponding Information Space. User agents may be defined which treat Information Spaces with special treatment and thus use techniques such a tabbed user interface to present various Information Spaces in separate tabs or other similar embodiment as per target device and application usage. Users may define Information Spaces at will or system may pre-define these. Further, users may share their definition and scope of Information Spaces with other users such as professional colleagues or group or family members, and may selectively allow such definition and scope to be changed by other users; and thus creating a pool of common interests or Information Spaces with documents, pages and elements that get automatically shared with other users in the pool. In an alternate implementation, Information Spaces defined by a user may be shared with public users, for the purpose of improving global search, and may allow public users or other consumers to view or change such a definition, leading to Information Spaces which serve common cause across consumers. [See FIG. 6]

A Mobile version of Information Engine with user designated Information Spaces for content allows friends to gain instant access to new information that their other friends in Information Space may have captured. It also permits instant propagation of interesting content to all friends which can be accessed via stringing of Information Spaces of all original recipients thus creating a fanning effect of information spread. It also eliminates the need to upload to sites such as YouTube, and yet makes the information available to public through the Information Engine in a relevance driven manner, all across the Internet if the originating user so desires.

By way of creating Information Spaces and assigning content to an Information Space, the Information Engine system enables mobile to mobile sharing right over the Internet, both one on one basis, and one to many basis as well as one to public basis, in a seamless manner, not possible today. Therefore this new method and system of Information Engine creates a powerful new medium of communication over established models of search engines as well as professional media web sites.

“Automatic Search”: an Automatic Search is performed when user enters words in a document using the Make features of the new system, and in coordination with the same, and in unobtrusive manner to the user, if the user so chooses, search results for the word are automatically shown on a separate panel. Such search results may include meaning of the word, and information and reference material with respect to the word. For example, if the word is Paris, then search will show Paris as a location and its associated reference-able information, which can help the user improve the creation. In a more moderate implementation, automatic search may only be responsive to title, headings, caption or automatically deduced topic words of a paragraph or the entire body or content.

“Automatic Advertising while Make”: Automatic advertising is when user enters words, sentences, paragraphs or caption of a figure, photo or video, in a document or web page, using the Make features of the new Information Engine, and in coordination with the same, and in unobtrusive manner to the user, advertising and sponsored web search results relevant to the document or words thereof are automatically shown on a separate panel. In a more moderate implementation, automatic advertising may only be responsive to title, headings, caption or automatically deduced topic words of current sentence, paragraph, body or content.

“Automatic Advertising while web browsing or searching”, in a user agent such as the Make-Share-Search Integrated user software, when viewing a web page, title, topic or context of web page is identified and sponsored links and/or sponsored web search results are shown in a search panel automatically. This model, shows contextually relevant sponsored results corresponding to user viewing any web page on the web. If sponsored web model is deployed, user may click-through a sponsored web result, for which the Information Engine gets paid, which then can optionally be shared as royalty with the web page provider or author of the new content, if such authors choose to receive royalty.

“Dynamic User Interface for Web Services”: Web Services presented on the Internet through SOAP, WSDL, RSS, HTTP/XML, REST, ATOM and other emerging forms of providing service oriented information and applications can be searched on the web and presented for selection to end users via the Information Engine. The search looks for available web services or online feed based interfaces, and matches the user online service requirement specified by keywords describing such a service to available ones; using the XML, WSDL or similar format file that describes the service, and shows all matches as search result. Once selected end users can add a selected service to their portfolio of such services and start using these using a dynamic UI, where a UI is automatically constructed for the web service using the UI definition information of the service. Acquisition of services information is done using web service crawl method which captures all WSDL, and other service descriptor standard files and uses these to create a search table for services. Relevance of a search result for a web service offering, in as compared to potentially hundreds of other similar service offerings which are also found, determines the order in which service is presented to the user. Service description and demonstration help determine the value of service to user. Relevance for such a web service is in a simple form determined by the number of users on the Internet which have engaged this service for the task descriptor keywords communicated by user. More complex relevance takes additional inputs of users to determine the full services required and hence creates a better match to the requirements. Further “global popularity index for each web service or its corresponding “service descriptor” document is defined and used along with dynamic relevance” to determine overall relevance of the service and information provided by it across all similar web services; as well as from other information sources, including traditional web pages.

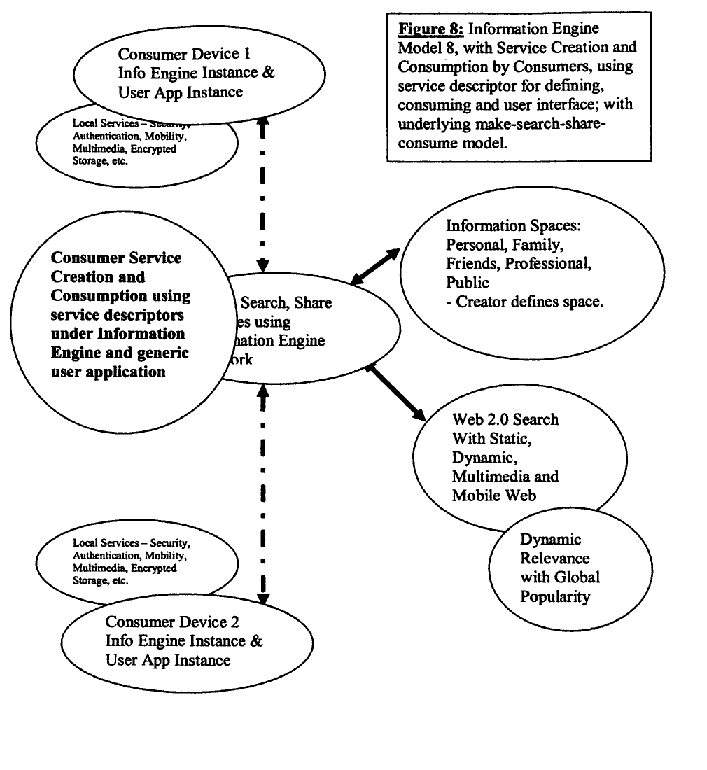

“Consumers providing Web Services via Information Engine”—The Information Engine not only allows use of web services from any where on the Internet, but also allows creation and publication of new service offering by the consumer, or business user to rest of consumers or business users. This is accomplished by user entering the type of service such as online service or offline service, and creating a “service description” through a user interface application such as the Make-Share-Search Integrated Application, or uploading a service descriptor file which is generic with format determined by the Information Engine, for all such consumer created service offerings. Once service description is verified and service validated by the Information Engine, through automated means, and the consumer confirms start of service, Information Engine from that point treats the service as part of its service provisions, and uses the service descriptor for search of services, whenever any other consumer on the Internet or mobile systems looks for such a service. If another consumer selects this service, Information Engine then establishes a live connection between the service consumer and service provider and enables service transaction if online or enables order of service or appointment for service if offline. The Information Engine gets paid by the service consumer as per percentage commission model based on price paid by the service consumer. Information Engine may alternately provide such a service free, through a sponsorship model, as per its business interests. [See FIG. 8]

Information Direct Model of Information Engine—Information is presented “directly”, by the Information Engine, “instead of” or “in addition” to links to information; Users click on link only when they want more details beyond directly presented information. This contrasts with present day search engines, which show links to information web sites and do not generically show information itself, except in some special cases such as local search; therefore users take several more steps to get to the information of interest. Information Direct, of the new Information Engine further is enhanced, by encouraging authors to create an abstract of information or news or product detail and allowing Information Engine to present the same to consumers looking for such information. This can be achieved by inserting a meta tag “information” or a special tab such as <info> within the web page or content page; and <mobile> or <mobileinfo>, or creating <.mobi> pages, in case of mobile friendly web pages, which are then processed by the Information Engine. Consumers get Information Directly as result upon search, along with an option to click through the associated link if the information presented encourages them to get more details. This model saves consumers significant time, as well as permits authors to get their message out much more quickly and thus attract consumer to visit their sites; while reducing false starts.

A new Information Direct model of Information Engine is defined, while present day search engines display results of a search by presenting various http links to web pages; in the new system, keywords when combined with dynamic context, will be used to present multi-media information in a box or other user interface model, for each corresponding link presented as part of search result. Authors of web pages can make use of special purpose XHTML tags created using the Make model, which will allow authors to control what is shown in the Information Direct model to consumers as search result. This could entail introduction of a new tag such as <info> that help present the main information in a concise way, while still giving the option to click on a corresponding link, which user may wish to for more detailed information. From a copyright view point, authors or website administrators can indicate if it is ok to show such Information Directly or not. By default the search engine will attempt to show the best information contained in the page, with respect to time or other context that user has asked for. The link to page shall also be shown for users to click for more information.

A “Sponsored Web” model of Information Engine that allows sponsorship of consumer content by advertisers, creates high value for consumers, as well as allows authors to show what will appeal most to the consumers, to enable consumers to seek more information by clicking on the corresponding link. Since information contained in a web page or provided by a web service may be copyrighted, authors and web service providers have to give their consent explicitly or implicitly for the new Information Direct Model, and thus enable this presentation. Further, this model may be combined with Sponsored web to create a unique situation where Information Direct display of information contained for a sponsored web content or web page results in a micro-royalty payment for the web author or service provider, as an option, if so chosen.

“Information Capsule” Model of Information Engine—delivers information automatically and periodically or on event basis, or a combination there-of, by the Information Engine, based on automatic search query and corresponding preferences presets by user. This model enables users to receive information of relevance to them even, without having to conduct a query again and again.

A new “Information Direct” or “Information capsule” model or a combination could replace present day snippets text, which is some text picked up around keywords on a page; and could additionally be popped in a box using technologies like AJAX, against a mouse over by user over the result link. Such information box may contain multi-media information such as thumbnails of photos etc. to make it more meaningful and attractive to the user, where such preview content is either automatically generated, or in combination with the Make model, be provided by authors embedded in the main web page through special purpose tags i.e. <Info > tag; which is then presented as part of information result, instead of snippets.

“E-neighborhood search”—In an extended implementation of Information Engine, a notion of electronic neighborhood or e-neighborhood is defined that captures all that pertains to a specific user, through user entry into various supportive software systems and applications that can interoperate with the new Information Engine. The Information Engine then uses that expanded set of information for information lookup and search, through cooperative data sharing with the corresponding application providing such data in terms of authenticity, timeliness and security of data. The Information Engine presents electronic neighborhood results separately or in addition to or mixed with global web search results as per end user preference. Hence through the Information Engine with e-neighborhood model, direct and personalized information is shown along with any global web search results, and usually, such information is more pertinent to end user than the generic web result. An example is by entering “Roger”, as query, address of your own friend Roger is shown along with his photo and possibly present location, if Roger allows you to see such information; In contrast, for a general search engine, i.e. without e-neighborhood, entering “Roger” would yield meaningless information for all the Internet web pages that contain the word “Roger”.

“Integrated Make-Share-Search User Software”: A dedicated UI capturing user search, web access and applications operations, with potential space for displaying sponsored web results, which relate to the information displayed in the main window of the UI; allowing for delivery of web pages, applications and search engine functionality with advertisements funded revenue model. This software can potentially replace the browser as well as explorer on the windows shell.

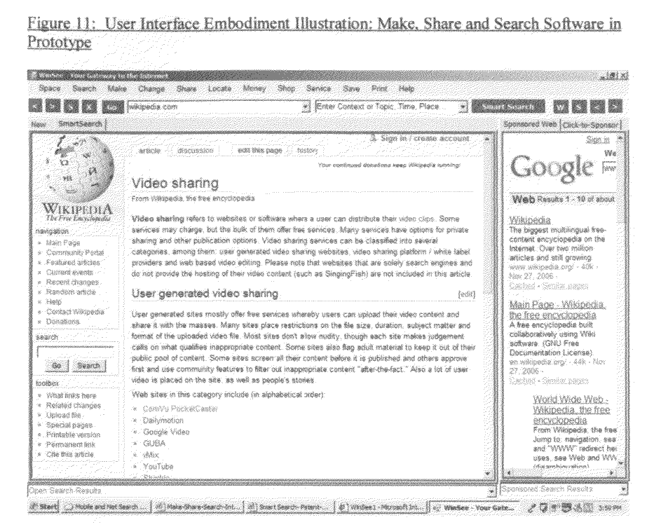

“Integrated Search User Interface”: An integrated user interface or user application which allows close interoperability between search engine operations and user operations of Information Engine. Unlike present day search results presentation via a web page with linear list of results, the new software will operate the search engine through application interface such as a “Simple Text Interface (STI)” or “SOA/Web Service Interface” and present search results in novel ways that are more friendly to end users beyond what standard browser based search results can achieve. The user application may be an enhanced browser with web access or may be integrated application software such as the Integrated Make-Share-Search User Application which uses search of the Internet as a core function of its application delivery model. [See FIG. 11: User Interface Embodiment Illustration ]

An optional extension, in the Make-Share-Search Integrated User Application, is for user to direct software to create tabs automatically for each search result returned, simplifying search navigation across results, during the results review process. Alternately, in another extension, in a media center environment, or remote controller environment, each search result may be automatically mapped to a key pad key on the controller; in yet another extension for a mobile phone or mobile device with numbered key on a keypad mapped to search result number, and pressing the key when in search mode, will automatically bring up information or preview of the web page, and/or take the user to the target web page. [Figure—User Interface Embodiment Illustration]

An optional extension, in the Make-Share-Search Integrated User Application, is to provide Multi-Search Engine Tabbed Interface—A new user interface is defined which allows for users to invoke multiple search engines, where each search engine is selected and assigned to a specific tab, and a single query can invoke all the various open search engines to get result. Clicking on any tab, brings forward or carries out search using the specific search engine associated by user with the specific tab, and thus with a single click user can search across a different search engine database, which is often useful, since no two search engines produce identical results. Further, a smart search tab is also defined which can present top 1 or 2 results from each of the user selected search engines, so that user can have best of information in one place.

An optional extension, in the Make-Share-Search Integrated User Application, is to provide a Fast Search capability, where a user selectable search engine or Information Engine searches for relevant results as the user enters the query by way of keyboard or by way of mobile phone keypad. This model reduces the need for users to enter full words and pressing enter or ok keys, while delivering dynamic results. To further optimize delivery of such fast results, Information Engine may cooperate with User Applications to create fast search channels of communication, and thus achieve the performance without server side degradation.

The above descriptions, embodiments, figures and illustrations exemplify the invention described herein and do not limit the applicability of the invention to new and emerging applications, devices and user environments.

What is claimed is:

1. A system of “Information Engine”, with “Make, Share, Browse, Search integrated model” which enables “Creation, Modification, Communication, Storage, Access, Viewing, Search, Prioritization, and Utilization of Information, Content, Media, Application or Service”, “Static or Dynamic”, “Consumer created or Professionals created or Applications or Software Service created”, in a “Uniform Global Architecture”, which is “Universally available on the web, on the Internet, on mobile phones, on smart devices and other form factor consumer and computing devices”.

2. The system of claim 1 wherein a set of the following are enabled:
Consumer=Author Model,
Consumer and Professional Creation and Consumption,
Make-Share-Browse-Search Integrated System,
Information-Media-Content-Application-or-Service,
Static or Dynamic,
Make-n-Share,
Make-n-Search,
Browse-n-Search,
Search-n-Share,
Three-to-N level multimedia information node model,
Web Creation-Search-Browse,
Multimedia Creation-Search-Utilization,
Mobile Creation-Search-Utilization,
Theme Creation-Search-Utilization,
Integrated Mobile Make-Share-Search-Browse system,
Services Creation-Search-Utilization,
Application Search-Utilization,
e-Neighborhood Creation-Search-Utilization,
Visible and Invisible web with discovery and utilization,
Directed Search,
Content comparator based search,
Information Direct,
Information Capsule,
Intelligent Information Container,
Information Spaces,
Dynamic Information Relevance,
Contextual Relevance,
User Will,
Security and Authentication,
Elimination of confidential data from public use,
Global Popularity Index,
Collective Wisdom,
Sponsored Web,
Sponsored consumer content,
Sponsored professional content,
Global Sponsorship,
Automatic Search,
Automatic advertising,
Fast Search,
Software As A Service,
Where a set may be zero, one or more of these aspects.

3. The system of claim 1 wherein the “Information Engine” additionally enables:
Replacing or Enhancing “web browser” and/or “user applications and agents” with either of integrated “make-n-search” or “make-n-share” or “search-n-share” or “browse-n-share” user agents, or applications or devices, or combination solutions targeting computers, computing devices, connected devices, mobile and/or smart devices, mobile telecommunication devices, global positioning devices, television reception devices, video cameras and other forms of user devices designed for capture, creation, communication, viewing or utilization of information, media, content and applications in the said system of Information Engine.

4. The system of claim 1 wherein the “Information Engine” additionally enables:
Replacing or Enabling search engine and search servers functions by said system of Information Engine, where the said system unifies at-least one of creation, modification, viewing, browsing, communication and utilization of information, content, media, applications and/or service with search operations including but not limited to search parameters collection, communication, assimilation, indexing, storage, prioritization, relevance based query processing, search results communication, information direct communication, localization and globalization of information and presentation for use, modification, consumption and/or utilization through user device, user agent or user applications or user service interfaces.

5. The system of claim 1 wherein the new “Information Engine” additionally enables:
Replacing or enabling information creation web page creation or document creation applications by Information Engine user agents, applications or devices or combinations thereof, to unify the functions “Creation, Modification, Communication, Storage, Access, Viewing, Browsing, Search, Prioritization, and Utilization of Information, Content and Media”.

6. A method of Information engine in which user software, user applications and/or user devices directly capture search parameters of any information, content or web page that a user creates, browsers, views, uses, access, or utilizes. These search parameters including but not limited to are common and uncommon words and/or phrases in a web page, titles and headers, markups and annotations, embedded URLs, images, videos, author stated keywords, author stated context, author implied context, user context and user environment parameters, themes, concepts and ideas inherent or explicit in the information, media, content, application or service are automatically captured, at user will with optional user specific capture, by user agents, user application and/or user devices and communicated to user designated Information Engine(s) which utilize these specific search parameters to dynamically update searchable index of information, thus creating a live search index which is globally current and constantly improving as users utilize the method.

7. The method of claim 6 wherein each capture of search parameters is utilized to improve the ability to search information, content, media, or application in proportion to or as a function representing global user interest, which may be sensitive to at-least one of frequency of usage, time of usage, time rate of usage, event of occurrence, time of occurrence, context of occurrence and other potential parameters indicative of user interest.

8. The method of claim 6 wherein search prioritization of Collective Wisdom shall utilize this dynamic user interest measurement from user agents, user applications and/or user devices at user will across a global user base or across a specific interest user base to automatically determine the relevancy of a search result or information to a specific user query or user agent query or user application query or user device query. This method thus enables dynamic search relevance which changes directly in context of user interest and avoids the need for pre-computed search priorities.

9. The method of claim 6 wherein search prioritization may alternately be pre-computed or may additionally be on demand computed utilizing “global popularity index” (GPI) based on context oriented limited patience user models and may optionally be combined with the collective wisdom to take advantage of both methods and improve performance

10. An advancement of Information Engines where Information Engine instance or specific variation of Information Engine are embedded in a device or dynamically downloaded and executed on a device, or a web site or plurality of web sites, or plurality of devices, at user will enabling the web site or device to participate in the Global Information Engine Network and System.

11. The method of claim 10 wherein device specific Information Engine shall interoperate two way i.e. send and receive information, content, media, applications or create and provide services to or with another device specific Information Engine to create a network of Information Engines, where each such Information Engine Network works to fulfill user agent, user application or user device instructions for information creation, storage, retrieval, search and utilization.

12. The method of claim 10 wherein each device Information Engine shall connect with a user designated central Information Engine to carry out authenticated information operations and be able to support state of the art communication and storage security protocols.

13. The method of claim 10 wherein advance applications including “Home Information Network” (HIN) and other new emerging applications can utilize the user specific device Information Engines in coordination with central or global Information Engines to create, store, access, search, operate and utilize information, content, media, applications and/or services for the benefit of the user or set of users.

14. The method of claim 10 wherein Make, Share, Search, Store, Access, Communicate, and/or Utilize operations of the user agent, user application and/or user device can utilize the user specific or global Information Engine network for user benefits in real time.

15. The method of claim 10 wherein user can utilize user agent, user application and/or user device on demand or in automated mode to create, capture, modify, enhance, integrate, execute, browse, search, view or utilize information, media, content, application or service utilizing the global Information Engine network for improved overall productivity and information utilization locally or remotely anywhere in the world.

16. The method of claim 10 wherein Information Engine network creates ability of user to create and utilize Information Spaces that span across various user devices, and may be based on topics and themes or may be based on user group or user context to share information, media, content, application or service with other participants that join or agree to join the specific Information Space.

17. The method of claim 10 wherein Information Spaces facilitate sharing and collaboration of Information by a user to participative other users of Information Space, utilizing the Information Engine network, and avoiding the need for emails or common or web based storage services. Information on demand is accessed via Information Engines and provided to the recipient directly from the source, participating in the Information Space, avoiding or reducing the need for large central storage areas thus creating an eco-friendly system.

18. A method of Sponsored Web where user or professional information, content, media, application or service is sponsored by an independent advertiser which creates motivation and earnings for the user or professional creator or user and wherein Information Engine System may share the proceeds of advertising revenue with the creators or providers or originators or aggregators of information, media, content, application or service based on actual utilization, with at will participation..

19. The method of claim 18 wherein advertisers can sponsor any user content utilizing the Information Engine network or Information Engine user agents, user applications or user devices in a competitive bidding or absolute pricing manner where such price is paid to the Information Engine System for each user click through, user view or user utilization of information, content, media, application or service.

20. The method of claim 18 wherein sponsored search can be conducted and presented to the user automatically with Automatic Advertising based on specific actions, contents, media, application or service that user is currently creating, viewing, browsing, searching, utilizing with the Information Engine network and system to present a richer and more informative environment for the user. Claim 21-51. (canceled)
